(19) United States
(12) Patent Application Publication
(10) Pub. No.: US 2024/0193361 A1
(43) Pub. Date: Jun. 13, 2024

(54) ELECTRONIC DEVICE FOR MANAGING DATA STANDARDS AND METHOD OF OPERATING THE SAME

(71) Applicant: ELECTRONICS AND TELECOMMUNICATIONS RESEARCH INSTITUTE, Daejeon (KR)

(72) Inventors: Jiwoo HAN, Daejeon (KR); Hee Sun WON, Daejeon (KR)

(21) Appl. No.: 18/524,434

(22) Filed: Nov. 30, 2023

(30) Foreign Application Priority Data
Dec. 9, 2022 (KR) 10-2022-0171841
Jun. 14, 2023 (KR) 10-2023-0076277

(51) Int. Cl. G06F 40/242; G06F 40/205

(52) U.S. Cl. CPC G06F 40/242; G06F 40/205

(57) ABSTRACT

Disclosed is an electronic device that receives, by a standard harvester, a first request indicating a collection operation of first standard information among a plurality of standard information from a user, parses, by the standard harvester, the first standard information to generate parsing information, generates, by the standard mapper, mapping information indicating parsing units based on the parsing information, generates, by the standard harvester, standard analysis information based on the parsing information and the mapping information, and stores, by the standard repository, the standard analysis information, and a standard management device that receives, by the standard mapper, a second request indicating a mapping operation of second standard information and third standard information among the plurality of standard information from the user, generates, by the standard mapper, relationship information indicating similarity between the second and the third standard mapping information, and stores, by the standard repository, the relationship information.

### CROSS-REFERENCE TO RELATED APPLICATIONS

This application claims priority under 35 U.S.C. § 119 to Korean Patent Application Nos. 10-2022-0171841 filed on Dec. 9, 2022, and 10-2023-0076277 filed on Jun. 14, 2023, respectively, in the Korean Intellectual Property Office, the disclosures of which are incorporated by reference herein in their entireties.

### BACKGROUND

### 1. Field of the Invention

Embodiments of the present disclosure described herein relate to management of data standards, and more particularly, relate to an electronic device for managing data standards and a method of operating the same.

### 2. Description of Related Art

As the amount of data and metadata collected in various fields increases, the importance of efficient data exchange and data management is increasing. However, data standards created by various standard organizations have different formats, and data follows specific data standard among several data standards. Therefore, there are difficulties in exchanging and managing data with different data standards.

Accordingly, electronic devices are required to collect different standards, map the different standards to each other, and analyze similarities.

### SUMMARY

Embodiments of the present disclosure provide an electronic device that manages data standards and a method of operating the same.

According to an embodiment of the present disclosure, an electronic device includes a standard organization set including a plurality of standard information, and a standard management device including a standard harvester, a standard mapper, and a standard repository, and the standard management device receives, by the standard harvester, a first request indicating a collection operation of first standard information among the plurality of standard information from a user, parses, by the standard harvester, the first standard information to generate parsing information, generates, by the standard mapper, mapping information indicating parsing units based on the parsing information, generates, by the standard harvester, standard analysis information based on the parsing information and the mapping information, and stores, by the standard repository, the standard analysis information, and the standard management device receives, by the standard mapper, a second request indicating a mapping operation of second standard information and third standard information among the plurality of standard information from the user, generates, by the standard mapper, relationship information indicating similarity between the second standard mapping information and the third standard mapping information, and stores, by the standard repository, the relationship information.

According to an embodiment, the standard harvester may include a specification collector that receives the first request from the user and receives the first standard information from the standard organization set depending on the first request, a specification parser that parses the first standard information to generate the parsing information, receives the mapping information from the standard mapper, and generates the standard analysis information based on the parsing information and the mapping information, and a specification standardizer that stores the standard analysis information into the standard repository.

According to an embodiment, the standard mapper may include a term mapper that generates term relationship information indicating similarity between terms of the second standard information and terms of the third standard information and stores the term relationship information into the standard repository, a vocabulary mapper that generates vocabulary relationship information indicating similarity between vocabularies of the second standard information and vocabularies of the third standard information and stores the vocabulary relationship information into the standard repository, and a specification mapper that generates specification relationship information indicating similarity between specifications of the second standard information and specifications of the third standard information and stores the specification relationship information into the standard repository, and a vocabulary may include two or more terms, and a specification may include two or more vocabularies.

According to an embodiment, the electronic device may further include a term manager that receives the term relationship information from the term mapper and stores the term relationship information, a vocabulary manager that receives the vocabulary relationship information from the vocabulary mapper and stores the vocabulary relationship information, and a specification manager that receives the specification relationship information from the specification mapper and stores the specification relationship information.

According to an embodiment, the parsing units may include a plurality of terms, a plurality of vocabularies, and a plurality of specifications, which correspond to the parsing information, and one vocabulary of the plurality of vocabularies may include two or more terms of the plurality of terms, and one specification of the plurality of specifications may include two or more vocabularies of the plurality of vocabularies.

According to an embodiment, the standard organization set may include a first standard organization and a second standard organization, the first standard organization may include fourth standard information, the second standard organization may include fifth standard information, the fourth standard information and the fifth standard information may support the same data standard, and a data format of the fourth standard information may be different from that of the fifth standard information.

According to an embodiment of the present disclosure, a method of operating an electronic device including a standard organization set, a standard harvester, a standard mapper, and a standard repository, includes receiving, by the standard harvester, a request indicating a collection operation of first standard information among a plurality of standard information from a user, parsing, by the standard harvester, the first standard information to generate parsing information, generating, by the standard mapper, mapping information indicating parsing units based on the parsing information, generating, by the standard harvester, standard analysis information based on the parsing information and the mapping information, and storing, by the standard repository, the standard analysis information.

According to an embodiment, the parsing units may include a plurality of terms, a plurality of vocabularies, and a plurality of specifications, which correspond to the parsing information, and one vocabulary of the plurality of vocabularies may include two or more terms of the plurality of terms, and one specification of the plurality of specifications may include two or more vocabularies of the plurality of vocabularies.

According to an embodiment, the generating, by the standard harvester, of the standard analysis information based on the parsing information and the mapping may include generating term information indicating terms included in terms of the first standard information among the plurality of terms, generating vocabulary information indicating vocabularies included in vocabularies of the first standard information among the plurality of vocabularies, and generating specification information indicating specifications included in specifications of the first standard information among the plurality of specifications, and the standard analysis information may include the term information, the vocabulary information, and the specification information.

According to an embodiment of the present disclosure, a method of operating an electronic device including a standard organization set, a standard mapper, and a standard repository, includes receiving, by the standard mapper, a request indicating a mapping operation of first standard information and second standard information among a plurality of standard information from a user, generating, by the standard mapper, relationship information indicating similarity between the first standard information and the second standard information, and storing, by the standard repository, the relationship information.

According to an embodiment, the generating, by the standard mapper, of the relationship information indicating the similarity between the first standard information and the second standard information may include generating term relationship information indicating similarity between terms of the first standard information and terms of the second standard information, generating vocabulary relationship information indicating similarity between vocabularies of the first standard information and vocabularies of the second standard information, and generating specification relationship information indicating similarity between specifications of the first standard information and specifications of the second standard information, and a vocabulary may include two or more terms, a specification includes two or more vocabularies, and the relationship information may include the term relationship information, the vocabulary relationship information, and the specification relationship information.

According to an embodiment, the generating of the vocabulary relationship information indicating the similarity between the vocabularies of the first standard information and the vocabularies of the second standard information may include generating the vocabulary relationship information based on terms included in each of the vocabularies of the first standard information and terms included in each of the vocabularies of the second standard information.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating an electronic device according to an embodiment of the present disclosure.

FIG. 2 is a diagram illustrating a standard harvester of FIG. 1 according to some embodiments of the present disclosure.

FIG. 3 is a diagram illustrating a standard mapper and standard repository of FIG. 1 according to some embodiments of the present disclosure.

FIG. 4 is a flowchart illustrating a collection operation of a standard management device, according to some embodiments of the present disclosure.

FIG. 5 is a flowchart illustrating a mapping operation of a standard management device, according to some embodiments of the present disclosure.

### DETAILED DESCRIPTION

Hereinafter, embodiments of the present disclosure will be described in detail and clearly to such an extent that an ordinary one in the art easily implements the present disclosure.

Hereinafter, to describe the technical idea of the present disclosure clearly, a description associated with identical components will be omitted.

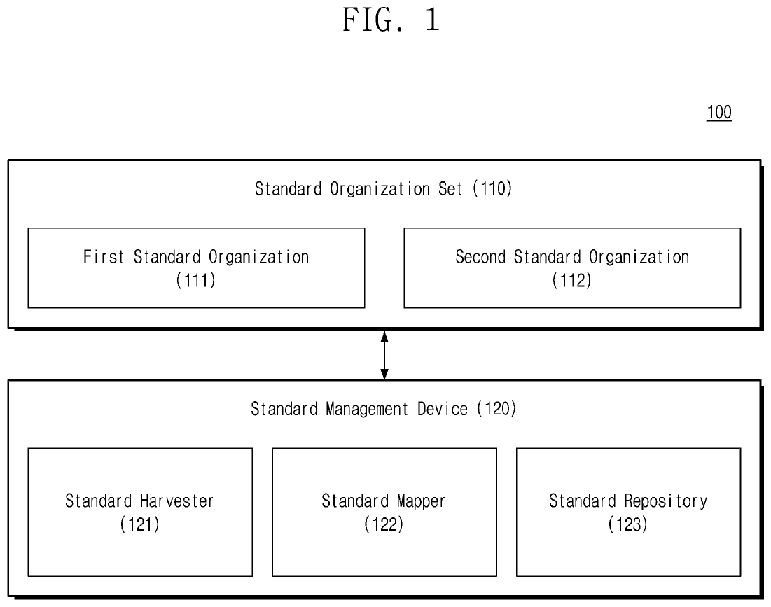

FIG. 1 is a block diagram illustrating an electronic device according to an embodiment of the present disclosure. Referring to FIG. 1, an electronic device 100 is illustrated.

The electronic device 100 may include various standard information and may manage various standard information. The standard information may include text information according to data standards. The data standards may be a specification by which data (e.g., text) is expressed. For example, types of the data standards may include an RDF (Resource Description Framework), a JSON (JavaScript Object Notation), etc.

The electronic device 100 may include a standard organization set 110 and a standard management device 120.

The standard organization set 110 may include a plurality of standard organizations. The standard organization may include a plurality of standard information. The standard information may have a corresponding data standard and a corresponding data format. The data standards may represent specifications for data management such as the RDF, the JSON, etc. The data format may represent detailed specifications within a data standard.

For example, the standard organization set 110 may include a first standard organization 111 and a second standard organization 112. The first standard organization 111 may include first standard information. The first standard information may have a corresponding data standard and may have one of several data formats within the corresponding data standard. Likewise, the second standard organization 112 may include second standard information. The second standard information may have a corresponding data standard and may have one of several data formats within the corresponding data standard.

In some embodiments, different standard organizations may support different data formats with respect to the same data standard. In more detail, the first and second standard organizations 111 and 112 may include the first standard information and the second standard information, respectively. The first standard information and the second standard information may support the same data standard, but each of the first and second standard information may have different data formats.

In FIG. 1, the standard organization set 110 is illustrated as including two standard organizations, but the scope of the present disclosure is not limited thereto, and the standard organization set may include more than two standard organizations.

The standard organization set 110 may provide standard information to the standard management device 120.

The standard management device 120 may request standard information from the standard organization set 110 according to a user request and may receive standard information. The standard management device 120 may collect standard information, and may map and store the standard information.

The standard management device 120 may include a standard harvester 121, a standard mapper 122, and a standard repository 123.

The standard harvester 121 may request standard information from a standard organization set according to a user request and may receive standard information. The standard harvester 121 may be connected to at least one of the standard organizations. The standard harvester 121 may generate standard analysis information by parsing the received standard information.

The parsing may refer to decomposing the components of text included in the standard information in units of parsing. The parsing unit may be any unit that has linguistic meaning within a text. For example, the parsing unit may be a specification, a vocabulary, or a term.

For example, a term may be a single word with a meaning. For example, terms may be identified by spaces. A vocabulary may include two or more terms. A specification may include two or more vocabularies. For example, the specification may be at least one phrase, clause, or sentence that describes the same subject matter.

The standard mapper 122 may receive a request indicating a mapping of two pieces of standard information. The standard mapper 122 may determine whether the user request is valid.

In some embodiments, the standards mapper 122 may determine that the user request is valid when each of the two pieces of standard information included in the user request is standard information that may be received from the standard organization set 110 by the standard harvester 121.

In response to determining that the user request is valid, the standard mapper 122 may generate relationship information by mapping the two pieces of standard information based on the similarity of the two pieces of standard information.

The standard repository 123 may receive and store the standard analysis information from the standard harvester 121. The standard repository 123 may receive and store the relationship information from the standard mapper 122.

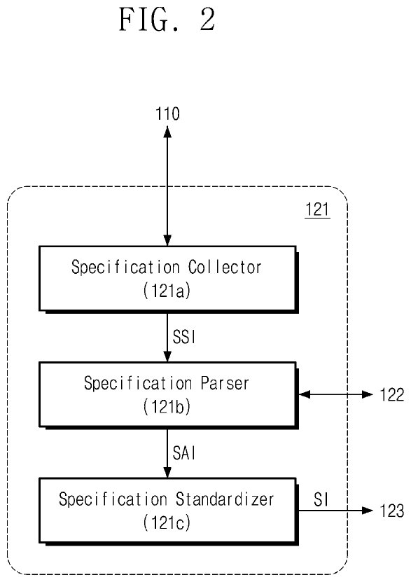

FIG. 2 is a diagram illustrating a standard harvester of FIG. 1 according to some embodiments of the present disclosure. Referring to FIG. 2, the detailed configuration of the standard harvester 121 is described. The standard harvester 121, the standard organization set 110, the standard mapper 122, and the standard repository 123 of FIG. 2 may correspond to the standard harvester 121, the standard organization set 110, the standard mapper 122, and the standard repository 123 of FIG. 1, respectively.

The standard harvester 121 may include a specification collector 121a, a specification parser 121b, and a specification standardizer 121c.

The specification collector 121a may receive a first request indicating a collection operation of one standard information SSI among a plurality of standard information included in the standard organization set 110 from the user. The specification collector 121a may determine whether the first request is valid. The specification collector 121a may determine that the first request is valid when the first request includes information indicating a standard organization that includes the standard information SSI.

The specification collector 121a may provide the standard information SSI to specification parser 121b in response to determining that the first request is valid.

The specification parser 121b may receive the standard information SSI from the specification collector 121a. The specification parser 121b may generate parsing information by parsing the standard information SSI. The parsing information may include term parsing information, vocabulary parsing information, and specification parsing information. The term parsing information may refer to all terms included in the standard information SSI. The vocabulary parsing information may refer to all vocabularies that may be created by combining terms included in the standard information SSI. The specification parsing information may refer to all specifications that may be created by combining vocabularies included in the vocabulary parsing information.

The parsing information may also include standard organization information. The standard organization information may be information indicating the standard organization that includes the standard information SSI.

The specification parser 121b may provide parsing information to the standard mapper 122. The specification parser 121b may receive mapping information from the standard mapper 122. The specification parser 121b receiving mapping information may be referred to as the specification parser 121b querying the mapping information in the standard mapper 122.

The mapping information may refer to the standard mapper 122 indicating parsing units based on parsing information. In detail, the mapping information may include terms, vocabularies, and specifications corresponding to the standard organization including the standard information SSI.

The specification parser 121b may generate standard analysis information SAI based on the parsing information and the mapping information. The standard analysis information SAI may include term information, vocabulary information, and specification information.

The term information may refer to terms included in parsing information among a plurality of terms included in the mapping information. The vocabulary information may refer to vocabularies included in parsing information among a plurality of vocabularies included in the mapping information. The specification information may refer to specifications included in parsing information among a plurality of specifications included in the mapping information.

The specification parser 121b may provide the standard analysis information SAI to the specification standardizer 121c.

The standard analysis information SAI may generate storage information SI by correcting or supplementing errors in the standard analysis information SAI. In specific cases, the storage information SI may be the same as standard analysis information SAI.

The specification parser 121b may provide the storage information SI to the standard repository 123.

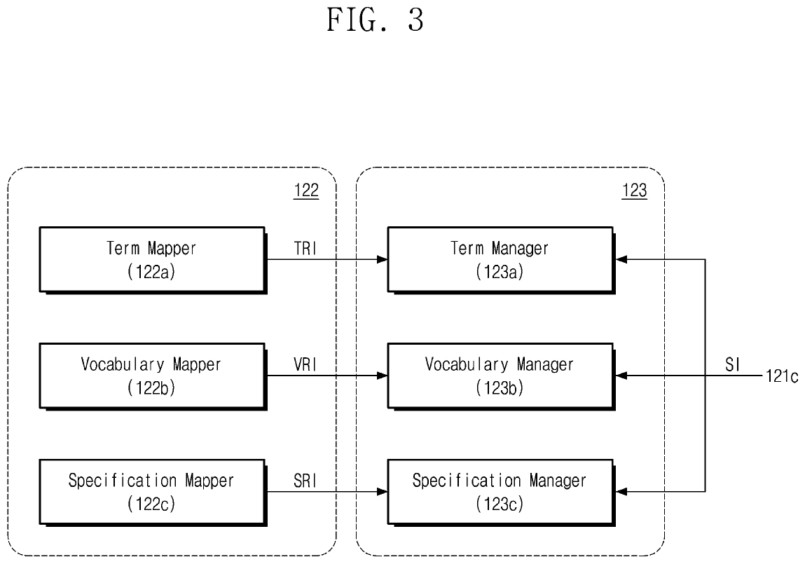

FIG. 3 is a diagram illustrating a standard mapper and standard repository of FIG. 1 according to some embodiments of the present disclosure. Referring to FIG. 3, the detailed configuration of each of the standard mapper 122 and the standard repository 123 is described. The standard mapper 122 and the standard repository 123 of FIG. 3 may correspond to the standard mapper 122 and standard repository 123 of FIG. 1. The specification standardizer 121c of FIG. 3 may correspond to the specification standardizer 121c of FIG. 2.

The standard mapper 122 may include a term mapper 122a, a vocabulary mapper 122b, and a specification mapper 122c.

The term mapper 122a may receive a request indicating a mapping operation of first standard information and second standard information from a user. The term mapper 122a may generate term relationship information TRI indicating similarity between terms of the first standard information and terms of the second standard information. Similarity between terms may refer to the degree to which the meanings between terms are similar to each other. For example, similarities may be identical, similar, dissimilar, and contrasting.

The vocabulary mapper 122b may receive a request indicating a mapping operation of the first standard information and the second standard information from the user. The vocabulary mapper 122b may generate vocabulary relationship information VRI indicating similarity between vocabularies of the first standard information and vocabularies of the second standard information. The similarity between vocabularies may refer to the degree to which the meanings between vocabularies are similar to each other.

In some embodiments, the similarity between vocabularies may be calculated based on similarity between terms that make up each of the vocabularies. In this case, the vocabulary mapper 122b may request term relationship information TRI from the term mapper 122a.

The specification mapper 122c may receive a request indicating a mapping operation of the first standard information and the second standard information from the user. The specification mapper 122c may generate specification relationship information SRI indicating similarity between specifications of the first standard information and specifications of the second standard information. The similarity between specifications may refer to the degree to which the meaning between specifications is similar to each other.

The standard repository 123 may include a term manager 123a, a vocabulary manager 123b, and a specification manager 123c.

The term manager 123a may receive the term relationship information TRI from the term mapper 122a. The term manager 123a may receive the storage information SI from the specification standardizer 121c. The term manager 123a may store terms of the term relationship information TRI and the storage information SI.

The vocabulary manager 123b may receive the vocabulary relationship information VRI from the vocabulary mapper 122b. The vocabulary manager 123b may receive the storage information SI from the specification standardizer 121c. The vocabulary manager 123b may store vocabularies of the vocabulary relationship information VRI and the storage information SI.

The specification manager 123c may receive the specification relationship information SRI from the specification mapper 122c. The specification manager 123c may receive the storage information SI from the specification standardizer 121c. The specification manager 123c may store specifications of the specification relationship information SRI and the storage information SI.

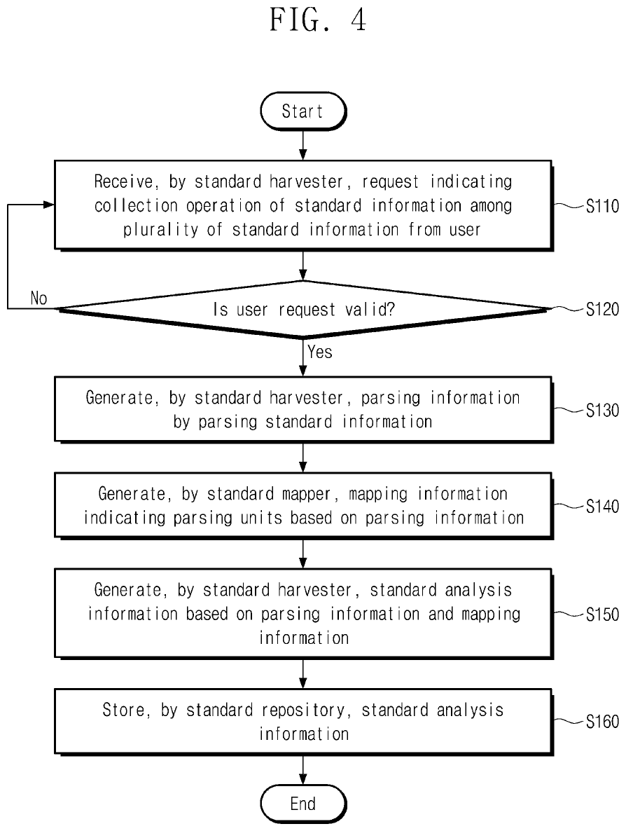

FIG. 4 is a flowchart illustrating a collection operation of an electronic device, according to some embodiments of the present disclosure. Referring to FIG. 4, a collection operation of an electronic device of FIG. 1 is described. The standard harvester, the standard mapper, and the standard repository of FIG. 4 may correspond to the standard harvester 121, the standard mapper 122, and the standard repository 123 of FIG. 1, respectively.

In operation S110, the electronic device may receive, by the standard harvester, a request indicating a collection operation of standard information among a plurality of standard information from the user.

In operation S120, the electronic device may determine whether the user request is valid.

In some embodiments, the electronic device may perform operation S110 again when it is determined that the user request is invalid. When it is determined that the user request is valid, operation S130 may be performed.

In operation S130, the electronic device may generate parsing information by parsing standard information using a standard harvester.

In operation S140, the electronic device may generate mapping information indicating parsing units based on the parsing information using the standard mapper.

In operation S150, the electronic device may generate the standard analysis information based on parsing information and mapping information by the standard harvester.

In some embodiments, operation S150 may include generating term information indicating terms included in parsing information among terms in the mapping information, and generating vocabulary information indicating vocabularies included in the parsing information among the vocabularies of the mapping information, and generating specification information indicating specifications included in parsing information among specifications of mapping information. In this case, the standard analysis information may include term information, vocabulary information, and specification information.

In addition, the electronic device may sequentially generate the term information, the vocabulary information, and the specification information, or may generate the term information, the vocabulary information, and the specification information in parallel.

In operation S160, the electronic device may store the standard analysis information using the standard repository.

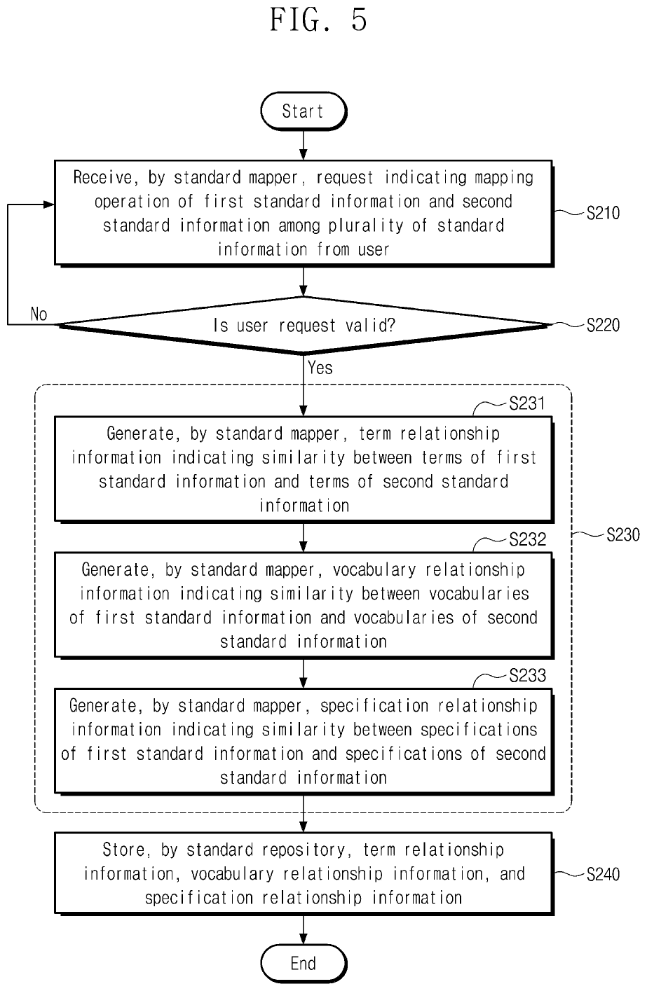

FIG. 5 is a flowchart illustrating a mapping operation of an electronic device, according to some embodiments of the present disclosure. Referring to FIG. 5, a collection operation of an electronic device 1 is described. A standard mapper and a standard repository of FIG. 5 may correspond to the standard mapper 122 and the standard repository 123 of FIG. 1, respectively.

In operation S210, the electronic device may receive a request indicating a mapping operation of first standard information and second standard information among a plurality of standard information from the user using the standard mapper.

In operation S220, the electronic device may determine whether the user request is valid using the standard mapper.

In some embodiments, the electronic device may perform operation S210 again in response to determining that the user request is invalid. In contrast, the electronic device may perform operation S230 in response to determining that the user request is valid.

In operation S230, the electronic device may generate relationship information indicating similarity between the first standard information and the second standard information using the standard mapper.

In some embodiments, operation S230 may include operations S231, S232, and S233.

In operation S231, the electronic device may generate term relationship information indicating similarity between terms of the first standard information and terms of the second standard information using the standard mapper.

In operation S232, the electronic device may generate vocabulary relationship information indicating similarity between vocabularies of the first standard information and vocabularies of the second standard information using the standard mapper.

In some embodiments, operation S232 may include generating vocabulary relationship information based on terms included in each of the vocabularies of the first standard information and terms included in each of the vocabularies of the second standard information.

In operation S233, the electronic device may generate, by the standard mapper, specification relationship information indicating similarity between specifications of the first standard information and specifications of the second standard information.

Operations S231 to S233 are illustrated as being performed sequentially, but the scope of the present disclosure is not limited thereto, and the order of operations S231 to S233 may be changed, or operations S231 to S233 may be performed in parallel.

In operation S240, the electronic device may store, by a standard repository, the term relationship information, the vocabulary relationship information, and the specification relationship information.

According to an embodiment of the present disclosure, an electronic device that manages data standards and a method of operating the same are provided.

In addition, according to an embodiment of the present disclosure, an electronic device with increased user convenience is provided by collecting standards from a standards organization in response to a standard collection request from a user and analyzing the standards by parsing the collected standards, or by analyzing the relationship between different standards by mapping different standards in response to a standard mapping request from the user.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalents to the claims of the present disclosure.

What is claimed is:

1. An electronic device comprising:
a standard organization set including a plurality of standard information; and
a standard management device including a standard harvester, a standard mapper, and a standard repository,
wherein the standard management device is configured to: receive, by the standard harvester, a first request indicating a collection operation of first standard information among the plurality of standard information from a user; parse, by the standard harvester, the first standard information to generate parsing information; generate, by the standard mapper, mapping information indicating parsing units based on the parsing information; generate, by the standard harvester, standard analysis information based on the parsing information and the mapping information; and store, by the standard repository, the standard analysis information, and
wherein the standard management device is configured to: receive, by the standard mapper, a second request indicating a mapping operation of second standard information and third standard information among the plurality of standard information from the user; generate, by the standard mapper, relationship information indicating similarity between the second standard mapping information and the third standard mapping information; and store, by the standard repository, the relationship information.

2. The electronic device of claim 1, wherein the standard harvester includes:
a specification collector configured to receive the first request from the user and receive the first standard information from the standard organization set depending on the first request;
a specification parser configured to parse the first standard information to generate the parsing information, receive the mapping information from the standard mapper, and generate the standard analysis information based on the parsing information and the mapping information; and
a specification standardizer configured to store the standard analysis information into the standard repository.

3. The electronic device of claim 1, wherein the standard mapper includes:
a term mapper configured to generate term relationship information indicating similarity between terms of the second standard information and terms of the third standard information, and store the term relationship information into the standard repository;
a vocabulary mapper configured to generate vocabulary relationship information indicating similarity between vocabularies of the second standard information and vocabularies of the third standard information, and store the vocabulary relationship information into the standard repository; and
a specification mapper configured to generate specification relationship information indicating similarity between specifications of the second standard information and specifications of the third standard information, and store the specification relationship information into the standard repository, and
wherein a vocabulary includes two or more terms, and a specification includes two or more vocabularies.

4. The electronic device of claim 3, further comprising:
a term manager configured to receive the term relationship information from the term mapper and store the term relationship information;
a vocabulary manager configured to receive the vocabulary relationship information from the vocabulary mapper and store the vocabulary relationship information; and
a specification manager configured to receive the specification relationship information from the specification mapper and store the specification relationship information.

5. The electronic device of claim 1, wherein the parsing units include a plurality of terms, a plurality of vocabularies, and a plurality of specifications, which correspond to the parsing information, and
wherein one vocabulary of the plurality of vocabularies includes two or more terms of the plurality of terms, and one specification of the plurality of specifications includes two or more vocabularies of the plurality of vocabularies.

6. The electronic device of claim 1, wherein the standard organization set includes a first standard organization and a second standard organization,
wherein the first standard organization includes fourth standard information,
wherein the second standard organization includes fifth standard information, and
wherein the fourth standard information and the fifth standard information support the same data standard, and a data format of the fourth standard information is different from that of the fifth standard information.

7. A method of operating an electronic device including a standard organization set including a plurality of standard information, a standard harvester, a standard mapper, and a standard repository, the method comprising:
receiving, by the standard harvester, a request indicating a collection operation of first standard information among the plurality of standard information from a user;
parsing, by the standard harvester, the first standard information to generate parsing information;
generating, by the standard mapper, mapping information indicating parsing units based on the parsing information;
generating, by the standard harvester, standard analysis information based on the parsing information and the mapping information; and
storing, by the standard repository, the standard analysis information.

8. The method of claim 7, wherein the parsing units include a plurality of terms, a plurality of vocabularies, and a plurality of specifications, which correspond to the parsing information, and
wherein one vocabulary of the plurality of vocabularies includes two or more terms of the plurality of terms, and one specification of the plurality of specifications includes two or more vocabularies of the plurality of vocabularies.

9. The method of claim 8, wherein the generating, by the standard harvester, of the standard analysis information based on the parsing information and the mapping includes:
generating term information indicating terms included in terms of the first standard information among the plurality of terms;
generating vocabulary information indicating vocabularies included in vocabularies of the first standard information among the plurality of vocabularies; and
generating specification information indicating specifications included in specifications of the first standard information among the plurality of specifications, and
wherein the standard analysis information includes the term information, the vocabulary information, and the specification information.

10. A method of operating an electronic device including a standard organization set, a standard mapper, and a standard repository, the method comprising:
receiving, by the standard mapper, a request indicating a mapping operation of first standard information and second standard information among the plurality of standard information from a user;
generating, by the standard mapper, relationship information indicating similarity between the first standard information and the second standard information; and
storing, by the standard repository, the relationship information.

11. The method of claim 10, wherein the generating, by the standard mapper, of the relationship information indicating the similarity between the first standard information and the second standard information includes:
generating term relationship information indicating similarity between terms of the first standard information and terms of the second standard information;
generating vocabulary relationship information indicating similarity between vocabularies of the first standard information and vocabularies of the second standard information; and
generating specification relationship information indicating similarity between specifications of the first standard information and specifications of the second standard information, and
wherein a vocabulary includes two or more terms, a specification includes two or more vocabularies, and the relationship information includes the term relationship information, the vocabulary relationship information, and the specification relationship information.

12. The method of claim 11, wherein the generating of the vocabulary relationship information indicating the similarity between the vocabularies of the first standard information and the vocabularies of the second standard information includes:
generating the vocabulary relationship information based on terms included in each of the vocabularies of the first standard information and terms included in each of the vocabularies of the second standard information.
